(19) United States
(12) Patent Application Publication
(10) Pub. No.: US 2017/0216993 A1
(43) Pub. Date: Aug. 3, 2017

(54) COMPOSITION FOR POLISHING TITANIUM ALLOY MATERIAL

(71) Applicant: FUJIMI INCORPORATED, Kiyosu-shi, Aichi (JP)

(72) Inventors: Maiko ASAI, Kiyosu-shi, Aichi (JP); Kazusei TAMAI, Kiyosu-shi, Aichi (JP); Hitoshi MORINAGA, Kiyosu-shi, Aichi (JP); Hiroshi ASANO, Kiyosu-shi, Aichi (JP)

(73) Assignee: FUJIMI INCORPORATED, Kiyosu-shi, Aichi (JP)

(21) Appl. No.: 15/501,530

(22) PCT Filed: May 1, 2015
(86) PCT No.: PCT/JP2015/063149

§ 371 Date: Feb. 3, 2017

(30) Foreign Application Priority Data
Aug. 7, 2014 (JP) 2014-161790

(51) Int. Cl. B24B 37/24; C09G 1/02

(52) U.S. Cl. CPC B24B 37/24; C09G 1/02

(57) ABSTRACT

Provided is a composition for polishing a titanium alloy material, which enables polishing of a titanium alloy material at a high polishing speed and can provide a polished titanium alloy material having excellent surface smoothness and having a highly glossy surface after polishing.

The composition for polishing a titanium alloy material is a composition that is intended for polishing a titanium alloy material and comprises a compound having a function of dissolving at least one metal element other than titanium, which exists at a content of more than 0.5% by mass with respect to the total mass of the titanium alloy material, at a higher degree of solubility than that of titanium; and abrasive grains.

### TECHNICAL FIELD

The present invention relates to a composition for polishing a titanium alloy material.

### BACKGROUND ART

An alloy is a material having metallic properties, which is obtained by incorporating, into one kind of metal element, one or more other metal elements or non-metal elements such as carbon, nitrogen and silicon. Alloys are produced for the purpose of enhancing properties such as mechanical strength, chemical resistance, corrosion resistance, and heat resistance, compared to pure metals.

Among various alloys, since titanium alloys are lightweight and have high strength and excellent corrosion resistance, titanium alloys are widely used for precision equipment, decorative articles, tools, sports goods, medical components and the like.

It is necessary to mirror finish the surface of an alloy depending on the applications. Examples of the mirror finishing method include painting or coating of the alloy surface. However, if mirror finish can be realized by polishing of an alloy surface, an advantage surpassing painting or coating can be obtained. For example, since polishing can provide a superior mirror surface compared to painting, painting or coating processes and materials used for those processes become unnecessary. Furthermore, since a mirror surface produced by polishing has higher durability compared to a mirror surface produced by painting, the mirror surface lasts for an extended period of time.

Conventionally, with regard to titanium, titanium nitride or the like, which are all processing-resistant materials, smoothening and mirror finish of the surface by variously devised polishing have been attempted. For example, it is disclosed in U.S. Pat. No. 5,516,346 B and JP 10-067986 A that when a halogen compound such as a fluoride salt or a fluorine compound is added to a polishing slurry, high selectivity to titanium, titanium nitride or the like is achieved. Furthermore, for example, it is disclosed in JP 2001-500188 A (corresponding to U.S. Pat. No. 5,770,103 B) and the like that when a monosubstituted to trisubstituted phenol having a polar group is added to an aqueous slurry, a high removal speed can be achieved for titanium and titanium nitride. In addition, for example, it is disclosed in JP 2005-244123 A (corresponding to US 2005/191823 A) and the like that when colloidal silica is used as a polishing agent, and the pH is adjusted to be 6 or lower, a high polishing speed is achieved for titanium, titanium nitride and the like.

### SUMMARY OF INVENTION

However, the polishing speeds generated by the polishing compositions described in the above-mentioned Patent Literatures for titanium alloy materials are not sufficient, and a polishing composition which can achieve even a higher polishing speed for titanium alloy materials has been desired. Furthermore, there is a problem that the surface of the titanium alloy material after polishing (polished titanium alloy material) has insufficient smoothness, and a highly glossy surface is not obtainable.

Therefore, the present invention was achieved in view of such circumstances, and it is an object of the invention to provide a composition for polishing a titanium alloy material, which enables polishing of a titanium alloy material at a high polishing speed and can provide a polished titanium alloy material having excellent surface smoothness and having a highly glossy surface after polishing.

It is another object of the present invention to provide a method for producing the above-described composition for polishing a titanium alloy material, and a method for producing a polished titanium alloy material, the method including a polishing step using the composition for polishing a titanium alloy material.

The inventors of the present invention conducted a thorough investigation in view of the problems described above. As a result, the inventors found that the problems described above can be solved by a composition for polishing a titanium alloy material, which has a configuration as described below, and thus, the inventors completed the present invention.

That is, the problems of the present invention as described above are solved by a composition for polishing a titanium alloy material, which is intended for polishing a titanium alloy material and contains a compound that has a function of dissolving at least one metal element other than titanium, which is contained in the titanium alloy material at a content of more than 0.5% by mass with respect to the total mass of the titanium alloy material, at a higher degree of solubility than that of titanium; and abrasive grains.

### DESCRIPTION OF EMBODIMENTS

An embodiment of the present invention relates to a composition for polishing a titanium alloy material, which is intended for polishing a titanium alloy material and contains a compound that has a function of dissolving at least one metal element other than titanium, which is contained in the titanium alloy material at a content of more than 0.5% by mass with respect to the total mass of the titanium alloy material, at a higher degree of solubility than that of titanium; and abrasive grains. When a composition for polishing a titanium alloy material according to an embodiment of the present invention having such a configuration is used, a titanium alloy material can be polished at a high polishing speed, and a polished titanium alloy material having excellent surface smoothness after polishing and having a highly glossy surface can be obtained. According to an embodiment of the present invention, there may be provided a composition for polishing a titanium alloy material, which enables polishing of a titanium alloy material at a high polishing speed and can provide a polished titanium alloy material having excellent surface smoothness and having a highly glossy surface after polishing. According to another embodiment of the present invention, a method for producing the above-mentioned composition for polishing a titanium alloy material, and a method for producing a polished titanium alloy material, the method including a polishing step of using the above-mentioned composition for polishing a titanium alloy material, may be provided.

Another embodiment of the present invention relates to a method for producing the above-mentioned composition for polishing a titanium alloy material.

Still another embodiment of the present invention relates to a method for producing a polished titanium alloy material, the method including a polishing step of using the above-mentioned composition for polishing a titanium alloy material.

The inventors of the present invention conducted an investigation in order to solve the problems described above. As a result, the inventors found that when a titanium alloy material is polished using a polishing composition containing a compound that has a function of dissolving at least one metal element other than titanium at a higher degree of solubility than that of titanium (hereinafter, also referred to as “metal solubility enhancer”); and abrasive grains, the polishing speed markedly increases, and smoothness of a polished titanium alloy material also increases.

Regarding the mechanism that explains how the problems described above can be solved by a “composition for polishing a titanium alloy material, the composition containing a metal solubility enhancer and abrasive grains”, which constitutes an embodiment of the present invention, the inventors of the present invention speculate the mechanism as follows. That is, in a polishing process for a titanium alloy material, when there is available a metal solubility enhancer that has a function of dissolving at least one metal element other than titanium, the metal element existing at a content of more than 0.5% by mass with respect to the total mass of the titanium alloy material, at a higher degree of solubility than that of titanium, the at least one metal element other than titanium is eluted from the titanium alloy material into the composition for polishing a titanium alloy material. Then, due to the elution of the at least one metal element other than titanium, which is an accessory component, the intermolecular force working on titanium that exists adjacently to the accessory component is reduced, and/or the boning of metal elements between titanium and accessory components in the vicinity of the titanium alloy material surface is broken, and titanium can easily break away from the titanium alloy material surface. Consequently, polishing is facilitated. As a result, it is speculated that the polishing speed for a titanium alloy material is increased, and smoothness of a polished titanium alloy material is also enhanced. The mechanism described above is based only on speculations, and whether the mechanism is correct or not is not intended to affect the technical scope of the present invention.

Hereinafter, embodiments of the present invention will be explained. The present invention is not intended to be limited only to the following embodiments. Furthermore, according to the present specification, the description “X to Y”, which indicates a range, means “more than or equal to X and less than or equal to Y”.

[Titanium Alloy Material]

The composition for polishing a titanium alloy material according to an embodiment of the present invention is used in applications for polishing titanium alloy materials. The titanium alloy material according to an embodiment of the present invention contains titanium, which is a main component, and at least one metal element other than titanium, which is an accessory component (hereinafter, also referred to as “metal element of accessory component”). The method for producing an alloy material is not particularly limited; however, for example, an alloy material obtainable by casting, forging, rolling or the like is preferred.

The alloy material is named based on the metal element that is contained as a main component. A titanium alloy material contains titanium as a main component. Here, when it is said that “contains titanium as a main component”, it means that the element that is contained in the largest proportion in the alloy is titanium. Furthermore, the titanium alloy material contains, for example, aluminum, iron, vanadium, tin, molybdenum, zinc, copper, chromium, or niobium, as the metal element other than titanium. Regarding the metal element other than titanium, it is preferable the titanium alloy material contains at least one selected from the group consisting of aluminum, vanadium, zinc, iron and copper, and it is more preferable that the titanium alloy material contains aluminum. Since aluminum is particularly easily soluble among the metal elements that are contained in titanium alloy materials, when the titanium alloy material contains aluminum, the titanium alloy material exhibits a noticeable increase of the polishing speed or a noticeable enhancement of smoothness.

The total content of the metal elements other than titanium in the titanium alloy material is more than 0.5% by mass, and preferably 1% by mass or more, with respect to the total amount of the alloy material. Furthermore, the total content of the metal elements of the accessory components in the titanium alloy material is not particularly limited; however, the total content of the metal elements of the accessory components is preferably less than 50% by mass, and more preferably 30% by mass or less. In a case in which two or more kinds of metal elements other than titanium are contained, the sum of the amounts is designated as the total content.

Furthermore, the content per element of the metal elements other than titanium, on which it is speculated that the composition for polishing a titanium alloy material according to an embodiment of the present invention works, should be larger than 0.5% by mass with respect to the total amount of the alloy material. That is, the titanium alloy material as an object of polishing of the present invention contains at least one metal element other than titanium, which is contained in an amount larger than 0.5% by mass with respect to the total mass of the titanium alloy material. This is because if the content is 0.5% by mass or less, the content becomes less than or equal to the contents of the elements present in unavoidable impurities, and the effects of the present invention are hardly obtainable. Here, unavoidable impurities are elements that are contained unintentionally in the materials for forming an alloy or in the alloy during the production process. Examples thereof include oxygen, nitrogen, and carbon, which respectively exist in a content of less than 0.5% by mass in the titanium alloy material.

The titanium (Ti) alloy material is not particularly limited as long as the material satisfies the conditions described above, and examples include corrosion resistant titanium alloy materials of types 11 to 23, Ti-1.5Al of type 50 (including 1.5% by mass of aluminum as a metal element of an accessory component), Ti-6Al-4V of type 60 and type 60-E (including 6% by mass of aluminum and 4% by mass of vanadium as metal elements of accessory components), Ti-3Al-2.5V of type 61 and type 61-F (including 3% by mass of aluminum and 2.5% by mass of vanadium as metal elements of accessory components), and Ti-4Al-22V of type 80 (including 4% by mass of aluminum and 22% by mass of vanadium as metal elements of accessory components) as described in JIS H4600:2012. Furthermore, as the titanium alloy material, Ti-5Al-2.5Sn (including 5% by mass of aluminum and 2.5% by mass of tin as metal elements of accessory components), Ti-8Al-1Mo-1V (including 8% by mass aluminum, 1% by mass of molybdenum, and 1% by mass of vanadium as metal elements of accessory components), Ti-6Al-6V-2Sn (including 6% by mass of aluminum, 6% by mass of vanadium, and 2% by mass of tin as metal elements of accessory components), Ti-6Al-2Sn-4Zr-6Mo (including 6% by mass of aluminum, 2% by mass of tin, 4% by mass of zirconium, and 6% by mass of molybdenum as metal elements of accessory components), Ti-3Al-8V-6Cr-4Zr-4Mo (including 3% by mass of aluminum, 8% by mass of vanadium, 6% by mass of chromium, 4% by mass of zirconium, and 4% by mass of molybdenum as metal elements as accessory components), Ti-10V-2Fe-3Al (including 10% by mass of vanadium, 2% by mass of iron, and 3% by mass of aluminum as metal elements of accessory components), Ti-15V-3Cr-3Sn-3Al (including 15% by mass of vanadium, 3% by mass of chromium, 3% by mass of tin, and 3% by mass of aluminum as metal elements of accessory components), Ti-5Al-1Fe (including 5% by mass of aluminum and 1% by mass of iron as metal elements of accessory components), Ti-1Cu (including 1% by mass of copper as a metal element of an accessory component), Ti-3Al-5V (including 3% by mass of aluminum and 5% by mass of vanadium as metal elements of accessory components), Ti-20V-4Al-1Sn (including 20% by mass of vanadium, 4% by mass of aluminum, and 1% by mass of tin as metal elements of accessory components), Ti-5Al-2Sn-2Zr-4Cr-4Mo (including 5% by mass of aluminum, 2% by mass of tin, 2% by mass of zirconium, 4% by mass of chromium, and 4% by mass of molybdenum as metal elements of accessory components), and the like may also be used.

Among the titanium alloy materials described above, from the viewpoint of having high solubility and contributing to weight reduction of the titanium alloy material, a titanium alloy material containing aluminum is preferred. The content of aluminum in a titanium alloy material containing aluminum is preferably larger than 0.5% by mass, and more preferably 1% by mass or more. Furthermore, the content of aluminum in a titanium alloy material containing aluminum is preferably less than 50% by mass, and more preferably 30% by mass or less. Among titanium alloy materials containing aluminum, from the viewpoint of all-purpose usability, Ti-1.5Al, Ti-6Al-4V, Ti-3Al-2.5V, Ti-4Al-22V, Ti-10V-2Fe-3Al, Ti-15V-3Cr-3Sn-3Al, and Ti-5Al-2Sn-2Zr-4Cr-4Mo are preferred; Ti-6Al-4V, Ti-3Al-2.5V, Ti-10V-2Fe-3Al, Ti-15V-3Cr-3Sn-3Al, and Ti-5Al-2Sn-2Zr-4Cr-4Mo are more preferred; and Ti-6Al-4V and Ti-3Al-2.5V are even more preferred.

The titanium alloy material may further contain a semi-metal element or a non-metal element.

[Metal Solubility Enhancer]

A metal solubility enhancer has a function of dissolving at least one metal element other than titanium, which exists at a content of more than 0.5% by mass or more with respect to the total mass of the titanium alloy material, at a higher degree of solubility than that of titanium. When it is described “having a function of dissolving”, the metal solubility enhancer may have a function of dissolving at least one of the metal elements of accessory components, or may have a function of dissolving a product obtainable as a result of a reaction between the metal solubility enhancer and at least one metal element of accessory components (in a case in which a plurality of reactions occur, the final product).

It is speculated that as a result of the action of the metal solubility enhancer, the composition for polishing a titanium alloy material according to an embodiment of the present invention markedly increases the polishing speed for a titanium alloy material, and enhances smoothness of a titanium alloy material after polishing.

Whether a metal solubility enhancer has a function of dissolving at least one metal element of accessory components existing at a content of more than 0.5% by mass with respect to the total mass of the titanium alloy material at a higher degree of solubility than that of titanium, can be checked by performing etching of simple titanium and simple metal elements of the accessory components, and determining the ratio of the respective etching rates thus measured. When the ratio of etching rates calculated by dividing the etching rate of at least one metal element of the accessory components by the etching rate of simple titanium is larger than 1, this indicates that the metal solubility enhancer has a function of dissolving at least metal element of the accessory components, which exists at a content of more than 0.5% by mass with respect to the total mass of the titanium alloy material, at a higher degree of solubility than that of titanium.

Regarding the method for measuring the etching rate, the method described in Examples can be used.

The metal solubility enhancer is not particularly limited as long as the effects of the present invention are obtained; however, for example, from the viewpoint of the solubility of metals, an acidic compound or a salt thereof can be used. Regarding the acidic compound, any of an inorganic acid compound and an organic acid compound may be used. Examples of the inorganic acid compound include, without any particular limitations, hydrochloric acid, sulfuric acid, nitric acid, hydrofluoric acid, boric acid, carbonic acid, hypophosphorous acid, phosphorous acid, and phosphoric acid. Examples of the organic acid compound include, without any particular limitations, formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, diglycolic acid, 2-furancarboxylic acid, 2,5-furandicarboxylic acid, 3-furancarboxylic acid, 2-tetrahydrofurancarboxylic acid, methoxyacetic acid, methoxyphenylacetic acid, phenoxyacetic acid, sulfonic acid, and phosphonic acid (for example, 1-hydroxyethane-1,1-diphosphonic acid). Examples of the salt include, without any particular limitations, an alkali metal salt, a salt of a Group 2 element, an aluminum salt, an ammonium salt, an amine salt, and a quaternary ammonium salt. From the viewpoint of the polishing effects per content, the metal solubility enhancer is preferably an organic acid compound or a salt thereof, and more preferably a divalent or higher-valent organic acid compound or a salt thereof. From the viewpoints of handleability and polishing effects, and in a case in which a solvent is used, from the viewpoint of solubility in the solvent (for example, water), the organic acid is preferably glycolic acid, malic acid, tartaric acid, succinic acid, maleic acid, oxalic acid, citric acid, propionic acid, glutaric acid, diglycolic acid, lactic acid, nitrilotrismethylenephosphonic acid, methanesulfonic acid, or 1-hydroxyethane-1,1-diphosphonic acid; more preferably diglycolic acid, succinic acid, citric acid, glutaric acid, nitrilotrismethylenephosphonic acid, methanesulfonic acid, or 1-hydroxyethane-1,1-diphosphonic acid; and even more preferably diglycolic acid, succinic acid, citric acid, glutaric acid, nitrilotrismethylenephosphonic acid, or methanesulfonic acid.

The content of the metal solubility enhancer is preferably 0.01% by mass or more, more preferably 0.02% by mass or more, and even more preferably 0.1% by mass or more. In a case in which the content of the metal solubility enhancer is within the range described above, the polishing speed for a titanium alloy material is increased. Furthermore, the content of the metal solubility enhancer is preferably 10% by mass or less, more preferably 7% by mass or less, and even more preferably 5% by mass or less. In a case in which the content of the metal solubility enhancer is within the range described above, the production cost for the composition for polishing a titanium alloy material can be reduced.

[Abrasive Grains]

Abrasive grains are mainly in charge of mechanical polishing processing in the composition for polishing a titanium alloy material. Specific examples of the abrasive grains include, without any particular limitations, aluminum oxide, silicon oxide, cerium oxide, zirconium oxide, titanium oxide, manganese oxide, silicon carbide, boron carbide, titanium carbide, titanium nitride, silicon nitride, titanium boride, and tungsten boride. Among these, from the viewpoint that surface roughness can be easily decreased, and low cost production can be realized, the abrasive grains are preferably particles of a metal oxide, and it is more preferable to use alumina (α-alumina, intermediate alumina, fumed alumina, alumina sol, or a mixture thereof), which enables attainment of high polishing speed and is readily available.

The particle size (D50) of the abrasive grains contained in the composition for polishing a titanium alloy material is preferably 0.1 μm or more, and more preferably 0.5 μm or more. In a case in which the particle size (D50) of the abrasive grains is within the range described above, the polishing speed for a titanium alloy material is increased. The particle size (D50) of the abrasive grains contained in the composition for polishing a titanium alloy material is preferably 10.0 μm or less, and more preferably 5.0 μm or less. In a case in which the particle size (D50) of the abrasive grains is within the range described above, it is easy to obtain a surface with fewer defects and low surface roughness. The particle size (D50) of the abrasive grains can be measured by a pore electrical resistance method (analyzer: MULTISIZER-III type, manufactured by Beckman Coulter, Inc.).

The specific surface area of the abrasive grains is preferably 2 m²/g or more, and more preferably 7 m²/g or more. The specific surface area of the abrasive grains can be measured by a gas adsorption method (BET method) disclosed in JIS Z8830:2001 (analyzer: manufactured by Shimadzu Corp., FLOWSORB II 2300).

The content of the abrasive grains in the composition for polishing a titanium alloy material is preferably 0.1% by mass or more, more preferably 0.2% by mass or more, and even more preferably 1% by mass or more. In a case in which the content of the abrasive grains is within the range described above, the polishing speed for an alloy generated by the composition for polishing a titanium alloy material is increased. The content of the abrasive grains in the composition for polishing a titanium alloy material is preferably 50% by mass or less, more preferably 25% by mass or less, and even more preferably 20% by mass. In a case in which the content of the abrasive grains is within the range described above, the production cost of the composition for polishing a titanium alloy material is reduced, and the amount of abrasive grains remaining on the alloy surface after polishing is reduced, so that cleanness of the alloy surface is enhanced.

[Other Components]

In addition to the components described above, the composition for polishing a titanium alloy material according to an embodiment of the present invention may contain, if necessary, for example, an etching agent that accelerates dissolution of an alloy material; an oxidizing agent that oxidizes the surface of an alloy material; a water-soluble polymer that acts on the surface of an alloy material or the surface of abrasive grains; a copolymer, a salt thereof, or a derivative thereof; an anticorrosive that suppresses corrosion of the surface of an alloy material; a chelating agent; a dispersion aid that facilitates redispersion of aggregates of abrasive grains; and components having other functions, such as an antiseptic agent and an antifungal agent.

Examples of the etching agent include, without any particular limitations, inorganic acids such as nitric acid, sulfuric acid, and phosphoric acid; organic acids such as acetic acid, citric acid, tartaric acid, and methanesulfonic acid; inorganic alkalis such as potassium hydroxide and sodium hydroxide; and organic alkalis such as ammonia, amine, and quaternary ammonium hydroxide.

Examples of the oxidizing agent include, without any particular limitations, hydrogen peroxide, peracetic acid, a percarbonate, urea peroxide, a perchlorate, and a persulfate.

Examples of the water-soluble polymer, copolymer, a salt thereof, and a derivative thereof include, without any particular limitations, polycarboxylic acids such as polyacrylic acid; polyphosphonic acid; polysulfonic acids such as polystyrenesulfonic acid; polysaccharides such as xanthan gum and sodium alginate; cellulose derivatives such as hydroxyethyl cellulose and carboxymethyl cellulose; polyethylene glycol, polyvinyl alcohol, polyvinylpyrrolidone, sorbitan monooleate; oxyalkylene-based polymers having a single kind or multiple kinds of oxyalkylene units; and salts thereof.

Examples of the anticorrosive include, without any particular limitations, amines, pyridines, tetraphenylphosphonium salts, benzotriazoles, triazoles, tetrazoles, and benzoic acid. Examples of the chelating agent include carboxylic acid-based chelating agents such as gluconic acid; amine-based chelating agents such as ethylenediamine, diethylenetriamine, and trimethyltetraamine; polyaminopolycarboxylic acid-based chelating agents such as ethylenediaminetetraacetic acid, nitrilotriacetic acid, hydroxyethylethylenediaminetriacetic acid, triethylenetetraminehexaacetic acid, and diethylenetriaminepentaacetic acid; organic phosphonic acid-based chelating agents such as 2-aminoethylphosphonic acid, 1-hydroxyethylidene-1,1-diphosphonic acid, aminotri(methylenephosphonic acid), ethylenediaminetetrakis(methylenephosphonic acid), diethylenetriaminepenta(methylenephosphonic acid), ethane-1,1-diphosphonic acid, ethane-1,1,2-triphosphonic acid, methanehydroxyphosphonic acid, and 1-phosphonobutane-2,3,4-tricarboxylic acid; phenolic derivatives; and 1,3-diketone.

Examples of the dispersion aid include condensed phosphates such as a pyrophosphate and a hexametaphosphate. Examples of the antiseptic agent include sodium hypochlorite. Examples of the antifungal agent include oxazolines such as oxazolidine-2,5-dione.

[Water]

It is preferable that the composition for polishing a titanium alloy material according to an embodiment of the present invention contains water as a dispersing medium or solvent for dispersing or dissolving various components. From the viewpoint of suppressing inhibition of the action of other components, water that does not contain impurities as far as possible is preferred, and specifically, pure water or ultrapure water, from which impurity ions have been removed using an ion exchange resin and then foreign materials have been removed through a filter, or distilled water is preferred.

[pH of Composition for Polishing Titanium Alloy Material]

The lower limit of the pH of the composition for polishing a titanium alloy material according to an embodiment of the present invention is preferably 1 or higher, and more preferably 1.5 or higher. When the pH of the composition for polishing a titanium alloy material is elevated, it is preferable because safety is enhanced.

Furthermore, the upper limit of the pH of the composition for polishing a titanium alloy material according to an embodiment of the present invention is preferably 7.0 or lower, more preferably 6.0 or lower, and even more preferably 4.5 or lower. As the pH of the composition for polishing a titanium alloy material becomes lower, it is preferable because the polishing rate increases.

The pH can be controlled by the metal solubility enhancer, which is one component of the composition for polishing a titanium alloy according to an embodiment of the present invention; however, the pH can also be controlled by using a known acid, a known base, or a salt thereof, in addition to the metal solubility enhancer.

[Composition for Polishing Titanium Alloy Material]

The composition for polishing a titanium alloy material according to an embodiment of the present invention contains, as described above, a compound having a function of dissolving at least one metal element other than titanium, which exists at a content of more than 0.5% by mass with respect to the total mass of the titanium alloy material, at a higher degree of solubility than that of titanium (metal solubility enhancer); and abrasive grains. Furthermore, as long as the effects of the present invention are not impaired, the composition for polishing a titanium alloy material may also contain other components as necessary. The composition for polishing a titanium alloy material of the present invention may be, for example, a composition containing an acid or an acidic compound, abrasive grains, and water. Examples of such a composition for polishing a titanium alloy material may be a composition for polishing a titanium alloy material having a pH value of from 1 to 7.

[Method for Producing Composition for Polishing Titanium Alloy Material]

The method for producing a composition for polishing a titanium alloy material according to an embodiment of the present invention is not particularly limited as long as the method involves mixing of the various components of the composition for polishing a titanium alloy material explained above. That is, the method may be any method containing a step of mixing a compound having a function of dissolving at least one metal element other than titanium, which exists in a titanium alloy material at a content of more than 0.5% by mass with respect to the total mass of the titanium alloy material (metal solubility enhancer), with abrasive grains. For example, a step of adding a metal solubility enhancer and abrasive grains to a dispersing medium, and mixing the components; a step of adding abrasive grains to a liquid-state metal solubility enhancer, and mixing the components; a step of adding abrasive grains to a metal solubility enhancer solution that has been produced in advance, and mixing the components; a step of adding a metal solubility enhancer to a dispersion liquid of abrasive grains that has been produced in advance, and mixing the components; and a step of mixing a metal solubility enhancer solution that has been produced in advance, with a dispersion liquid of abrasive grains that has been produced in advance, may be employed; however, the method is not limited to these steps. The conditions for mixing, the mixing method and the like may be arbitrarily selected. In addition to the mixing steps described above, the method may further include another step. Examples of the other step include a step of further adding a dispersing medium after mixing of the various components for constituting the composition for polishing a titanium alloy material; however, the other step is not intended to be limited to this.

The composition for polishing a titanium alloy material according to an embodiment of the present invention is not particularly limited, and the composition may be obtained by, for example, a method of mixing with stirring a metal solubility enhancer, abrasive grains (for example, alumina particles), and other components as necessary, in water.

The temperature employed at the time of mixing the various components is not particularly limited; however, the temperature is preferably from 10° C. to 40° C., and the components may be heated in order to increase the rate of dissolution. Furthermore, the mixing time is also not particularly limited.

[Method for Polishing Titanium Alloy Material, and Method for Producing Polished Titanium Alloy Material, which Includes Step of Polishing Titanium Alloy Material]

As described above, the composition for polishing a titanium alloy material according to an embodiment of the present invention is suitably used for polishing of a titanium alloy material. Therefore, according to another embodiment of the present invention, there is provided a polishing method of polishing a titanium alloy material using the composition for polishing a titanium alloy material according to an embodiment of the present invention. Furthermore, according to still another embodiment of the present invention, there is provided a method for producing a polished titanium alloy material, the method including a step of polishing a titanium alloy material by the polishing method described above.

Regarding the method for producing a polished titanium alloy material using the composition for polishing a titanium alloy material according to an embodiment of the present invention,

a method including:

supplying the composition for polishing a titanium alloy material according to an embodiment of the present invention, in between a polishing pad and a titanium alloy material,

pressing the polishing pad against the titanium alloy material, and

polishing the titanium alloy material by rotating or moving the polishing pad and/or the titanium alloy material,

can be used.

The method of pressing the polishing pad against the titanium alloy material is not particularly limited, and a method of pressing the polishing pad against the titanium alloy material, a method of pressing the titanium alloy material against the polishing pad, or a method combining both can all be used. Furthermore, the polishing method is not particularly limited, and a method of rotating or moving the polishing pad and a platen to which this polishing pad is attached, a method of rotating or moving the titanium alloy material and a holding tool that holds this titanium alloy material, or a method combining both can all be used.

When a titanium alloy material is polished using the composition for polishing a titanium alloy material according to an embodiment of the present invention, polishing can be carried out using an apparatus or conditions that are used for conventional metal polishing. Examples of a general polishing apparatus include a single-sided polishing apparatus and a double-sided polishing apparatus. In a single-sided polishing apparatus, a titanium alloy material is held using a holding tool called carrier, and one surface of the titanium alloy material is polished by pressing a platen having a polishing pad attached thereto, against one surface of the titanium alloy material while supplying a polishing composition, and then rotating the platen. In a double-sided polishing apparatus, a titanium alloy material is held using a holding tool called carrier, and both surfaces of the titanium alloy material are polished by pressing a polishing pad-attached platen against either surface of the titanium alloy material while supplying a polishing composition from above, and rotating those platens in opposite directions. In a general polishing apparatus, a titanium alloy material is polished in a state in which a polishing composition is supplied between a polishing pad and a titanium alloy material. At this time, polishing is achieved as a result of physical action caused by friction between a polishing pad as well as a polishing composition and a titanium alloy material, and chemical action brought by the polishing composition to the titanium alloy material.

As one of the polishing conditions for the polishing method according to another embodiment of the present invention, polishing load may be mentioned. Generally, as the load increases, the frictional force caused by abrasive grains increases, and the mechanical processing power is enhanced. Therefore, the polishing speed increases. The load for the polishing method according to the other embodiment of the present invention is not particularly limited; however, the load is preferably from 50 g/cm² to 1,000 g/cm², more preferably from 80 g/cm² to 800 g/cm², and even more preferably 100 g/cm² to 600 g/cm², per unit area of the titanium alloy material. When the load is in this range, a sufficient polishing speed is manifested, and the occurrence of damage to the titanium alloy material or defects such as scratches on the surface, which are both caused by load, can be suppressed.

Furthermore, as one of the polishing conditions for the polishing method according to the other embodiment of the present invention, the linear velocity for polishing may be mentioned. Generally, for example, the number of rotations of the polishing pad, the number of rotations of the carrier, the size of the titanium alloy material, the number of the titanium alloy material, and the like affect the linear velocity; however, in a case in which the linear velocity is high, since the frictional force applied to the titanium alloy material becomes large, the action by which edges are mechanically polished becomes significant. Furthermore, frictional heat is generated by friction, and the chemical action caused by the polishing composition may become significant. The linear velocity for the polishing method according to the present invention is not particularly limited; however, the linear velocity is preferably from 10 m/min to 300 m/min, and more preferably from 30 m/min to 200 m/min. When the linear velocity is in this range, a sufficient polishing speed can be obtained, and damage to the polishing pad caused by the friction of the titanium alloy material can be suppressed. Furthermore, friction is sufficiently transferred to the titanium alloy material, and a so-called state of sliding of the titanium alloy material can be prevented. Thus, polishing can be achieved sufficiently.

The polishing pad used for a polishing method of using the composition for polishing a titanium alloy material according to the embodiment of the present invention described above, may vary depending on the material, for example, a polyurethane type pad, a nonwoven fabric type pad, or a suede type pad, and on properties such as hardness and thickness. Furthermore, there may be a polishing pad which includes abrasive grains and a polishing pad which does not include abrasive grains, and it is preferable to use the latter.

As one of the polishing conditions for the polishing method according to the other embodiment of the present invention, the amount of supply of the composition for polishing a titanium alloy material may be mentioned. The amount of supply may vary depending on the type of the titanium alloy material to be polished, the polishing apparatus, and the polishing conditions; however, the amount of supply may be any amount sufficient for being evenly supplied over the entire surface between the titanium alloy material and the polishing pad. In a case in which the amount of supply of the composition for polishing a titanium alloy material is small, the composition for polishing a titanium alloy material may not be supplied over the entirety of the titanium alloy material, or the composition for polishing a titanium alloy material may dry up and solidify, causing defects on the surface of the titanium alloy material. In contrast, in a case in which the amount of supply is large, it is not economically efficient, and also, friction may be hindered by an excess amount of polishing composition, particularly the medium such as water, so that polishing is inhibited.

In regard to the polishing method according to the other embodiment of the present invention, polishing method can have a preliminary polishing step of using another polishing composition before the polishing step. In a case in which there are processing damages, scratches generated at the time of transport, and the like on the surface of the titanium alloy material surface, it takes a long time to mirror finish such scratches in a single process, it is economically inefficient, and there is a risk that smoothness may be impaired. By having the scratches on the surface of the titanium alloy material removed by the preliminary polishing step, the polishing time required for polishing according to the polishing method of the present invention can be shortened, and it can be expected to obtain an excellent mirror surface efficiently. Regarding the composition for preliminary polishing used for the preliminary polishing step, it is preferable to use a polishing composition having stronger polishing power compared to the composition for polishing a titanium alloy material according to the embodiment of the present invention. Specifically, it is preferable to use abrasive grains having higher hardness and a larger particle size, compared to the abrasive grains used for the composition for polishing a titanium alloy material according to the embodiment of the present invention.

When a titanium alloy material is polished using the composition for polishing a titanium alloy material according to the embodiment of the present invention, the composition for polishing a titanium alloy material that has been used once for polishing can be collected and used again for polishing. An example of the method of reusing the composition for polishing a titanium alloy material may be a method of collecting the composition for polishing a titanium alloy material, which has been discharged from a polishing apparatus, into a tank, and recycling the composition again into the polishing apparatus. Recycling of the composition for polishing a titanium alloy material is useful from the viewpoint that environmental burdens can be reduced by reducing the amount of the composition for polishing a titanium alloy material, which is discharged as waste water, and that the production cost required for polishing of a titanium alloy material can be lowered by reducing the amount of use of the composition for polishing a titanium alloy material.

When the composition for polishing a titanium alloy material according to an embodiment of the present invention is recycled, portions or entireties of the metal solubility enhancer, abrasive grains (for example, alumina particles), and other optional components, which have been consumed and lost as a result of polishing, can be added as composition regulating agents, during recycling.

In this case, regarding the composition regulating agents, a mixture prepared by mixing portions or entireties of the metal solubility enhancer, abrasive grains (for example, alumina particles), and other optional components at arbitrary mixing proportions, may be used. When the composition regulating agent is additionally added, the composition for polishing a titanium alloy material is regulated to a composition suitable for reuse, and polishing is adequately maintained. The concentrations of the metal solubility enhancer, abrasive grains (for example, alumina particles), and other optional components that are contained in the composition regulating agent are arbitrary and are not particularly limited, and it is preferable that the concentrations are appropriately adjusted depending on the size of the circulating tank or the polishing conditions.

The composition for polishing a titanium alloy material according to an embodiment of the present invention may be a one-liquid type, or may be a multi-liquid type including a two-liquid type. Furthermore, the composition for polishing a titanium alloy material according to an embodiment of the present invention may be prepared diluting a stock solution of the composition for polishing a titanium alloy material, for example, 10 times or more using a diluent such as water.

The arithmetic mean roughness Ra of the polished titanium alloy material that is produced according to the method for producing a polished titanium alloy material according to still another embodiment of the present invention, which method includes a step of polishing a titanium alloy material by the polishing method described above, is preferably 70 nm or less, more preferably 65 nm or less, even more preferably 50 nm or less, still more preferably 40 nm or less, and particularly preferably 30 nm or less. The arithmetic mean roughness can be measured using a non-contact surface morphology analyzer. The details of the analysis method will be described in the Examples.

### Examples

Next, the present invention will be more specifically described by way of Examples and Comparative Examples; however, the present invention is not intended to be limited to the following Examples only.

As abrasive grains, α-alumina (particle size (D50) 2.7 μm, analyzer: MULTISIZER III type manufactured by Beckman Coulter, Inc.) was prepared. In Comparative Example 1, a composition for polishing a titanium alloy material containing 14% by mass of abrasive grains with respect to the total mass of the composition for polishing a titanium alloy material was prepared by diluting the abrasive particles with water. In Examples 1 to 4 and Comparative Example 2, compositions for polishing a titanium alloy material each containing 14% by mass of abrasive grains with respect to the total mass of the composition for polishing a titanium alloy material, were prepared by diluting the abrasive grains with water, and adding the compounds of Table 1 to the composition in an amount that would give the pH indicated in Table 1 with respect to the total mass of the composition for polishing a titanium alloy material.

Here, the kinds of the compounds used in Examples and Comparative Examples are described as “Compound” in Table 1, and the pH of the compositions for polishing a titanium alloy material thus produced is described as “pH” in Table 1.

Also, titanium (Ti) and Ti-6Al-4V as a titanium alloy material were prepared. Ti-6Al-4V contains 6% by mass of aluminum and 4% by mass of vanadium with respect to the total mass of the titanium alloy material, with the balance being titanium and trace amounts of unavoidable impurities. Furthermore, simple aluminum (Al), which is one of the accessory components of Ti-6Al-4V, was prepared.

The ratios of the etching rates for titanium (Ti) and aluminum (Al) in the titanium alloy material generated by the various compounds used in the various compositions for polishing a titanium alloy of Examples 1 to 4 and Comparative Examples 1 and 2, were determined, and it was checked whether the various compounds were metal solubility enhancers. Furthermore, the polishing speeds for titanium and the titanium alloy material were determined using the various compositions for polishing a titanium alloy material of Examples and Comparative Examples. Furthermore, the surface roughness of the titanium alloy material obtainable after polishing by means of various compositions for polishing a titanium alloy material, was measured.

Various measurement methods and results are presented below.

<Ratio of Etching Rates>

From the ratios of etching rates, the function of dissolving titanium of the main component and the metal elements of the accessory components existing in the titanium alloy material, as provided by the various compounds used in the various compositions for polishing a titanium alloy of Examples 1 to 4 and Comparative Examples 1 and 2, was checked.

As a substrate for etching, one sheet of pure aluminum and one sheet of pure titanium (32×32×2 mm each) were prepared. Furthermore, as etching solutions, solutions produced by incorporating the various compounds respectively into pure water such that the solutions would have the same values of pH as those of the compositions for polishing a titanium alloy indicated in Table 1, were prepared. Each of the various substrates was placed in a 250-mL container and was immersed in 150 mL of an etching solution. After standing for 24 hours at 60° C., the substrate was taken out, and the various etching rates were calculated from the differences between the masses measured before and after etching. Here, the difference between the masses measured before and after etching represents the etching rate per day (24 hours). Then, the ratio of etching rates was determined using these measurement results for the various etching rates, by dividing the etching rate for Al by the etching rate for Ti. These results are presented in Table 1 under the title “Al/Ti etching rate ratio”. When this rate of etching rates is larger than 1, the compound was considered to be a metal solubility enhancer having a function of dissolving a metal element as an accessory component of the titanium alloy material (herein, aluminum) at a higher degree of solubility than that of titanium.

<Polishing Speed>

The titanium and the titanium alloy material were polished with a single-sided polishing machine, using the various compositions for polishing a titanium alloy material of Examples 1 to 4 and Comparative Examples 1 and 2. Specifically, the titanium alloy material was polished under the conditions described in Table 2, by holding the titanium alloy material with a holding tool, pressing a polishing cloth (polishing pad)-attached platen against one surface of the titanium alloy material and rotating the platen while supplying the composition for polishing a titanium alloy material.

The masses of titanium and the titanium alloy material were measured before the polishing step, and the masses of the polished titanium and the polished titanium alloy material were measured after the polishing step. The various polishing speeds were calculated from the differences between the masses obtained before and after the polishing step. These results are presented in Table 1 under the titles “Ti polishing speed” and “Ti-6Al-4V polishing speed”.

<Arithmetic Mean Roughness Ra>

For the polished titanium alloy materials that had been polished using the various compositions for polishing a titanium alloy of Examples 1 to 4 and Comparative Examples 1 and 2, the arithmetic mean roughness Ra was determined using a non-contact surface morphology analyzer (laser microscope VK-X200, manufactured by Keyence Corp.), by setting the measurement area size to 248×213 μm. These results are presented in Table 1 under the title “Ra”.

TABLE 1

| | | | Al/Ti | Ti | Ti—6Al—4V | |
|---|---|---|---|---|---|---|
| | | | etching | polishing | polishing | |
| | | | rate | speed | speed | Ra |
| | Compound | pH | ratio | [m/min] | [m/min] | [nm] |
| Example 1 | Sulfuric acid | 2.0 | 192 | 0.5 | 1.6 | 62 |
| Example 2 | Citric acid | 2.0 | 8 | 0.5 | 2.4 | 30 |
| Example 3 | Oxalic acid | 2.0 | 2 | 0.3 | 2.5 | 45 |
| Example 4 | 1-Hydroxyethane-1,1- | 2.0 | 242 | 0.5 | 2.4 | 33 |
| | diphosphonic acid | | | | | |
| Comparative | None | 6.9 | No | 0.4 | 0.8 | 74 |
| Example 1 | | | etching | | | |
| Comparative | KOH | 10.4 | No | 0.4 | 1.1 | 76 |
| Example 2 | | | etching | | | |

Meanwhile, in regard to the measurement of the etching rates for Comparative Examples 1 and 2 in Table 1, since etching of aluminum and titanium was not recognized, it is described as “No etching” for the etching rate ratio in Table 1.

TABLE 2
Polishing conditions

| Polishing machine | Single-sided polishing machine | |
|---|---|---|
| | (platen diameter 380 mm) | |
| Polishing pad | Nonwoven fabric type | |
| Load of polishing | 202 | g/cm² |
| Number of rotations of platen | 90 | rpm |
| Linear velocity | 72 | m/min |
| Polishing time | 10 | minutes |
| Temperature of polishing liquid | 20° | C. |
| Supply rate of polishing liquid | 14 | mL/min |

| | |
|---|---|
| Object of polishing | In the case of titanium polishing, |
| | titanium sheets (32 × 32 × 2 mm, 3 |
| | sheets) were simultaneously |
| | polished. |
| | In the case of titanium alloy |
| | material polishing, Ti—6Al—4V |
| | sheets (32 × 32 × 3 mm, 3 sheets) |
| | were simultaneously polished. |

As shown in Table 1, the polishing speed for the titanium alloy materials of Examples 1 to 4 had larger values compared to Comparative Examples 1 and 2. Furthermore, the Examples exhibited smaller values of Ra compared to the Comparative Examples. From these results, it is understood that in the various Examples, the polishing speeds for the titanium alloy material were faster, and polished titanium alloy materials having high smoothness and having a highly glossy surface can be obtained. On the other hand, in Comparative Examples, the polishing speeds were slow, and surface roughness was also high.

The present patent application is based on JP 2014-161790 filed on Aug. 7, 2014, the entire disclosure of which is incorporated herein by reference.

1.-8. (canceled)

9. A composition for polishing a titanium alloy material, the composition being intended for polishing a titanium alloy material, and comprising a compound having a function of dissolving at least one metal element other than titanium, which exists at a content of more than 0.5% by mass with respect to the total mass of the titanium alloy material, at a higher degree of solubility than that of titanium; and abrasive grains.

10. The composition for polishing a titanium alloy material according to claim 9, wherein the compound is an acidic compound or a salt thereof.

11. The composition for polishing a titanium alloy material according to claim 9, wherein the compound is an organic acid compound or a salt thereof.

12. The composition for polishing a titanium alloy material according to claim 9, wherein the abrasive grains are particles of a metal oxide.

13. The composition for polishing a titanium alloy material according to claim 9, wherein the abrasive grains are particles of alumina.

14. The composition for polishing a titanium alloy material according to claim 9, wherein the at least one metal element other than titanium is aluminum.

15. A method for producing a composition for polishing a titanium alloy material, the method comprising a step of mixing a compound having a function of dissolving at least one metal element other than titanium, which exists in the titanium alloy material at a content of more than 0.5% by mass with respect to the total mass of the titanium alloy material, at a higher degree of solubility than that of titanium, with abrasive grains.

16. A method for producing a polished titanium alloy material, the method comprising:
supplying the composition for polishing a titanium alloy material according to claim 9 in between a polishing pad and a titanium alloy material;
pressing the polishing pad against the titanium alloy material; and
polishing the titanium alloy material by rotating or moving the polishing pad and/or the titanium alloy material.

17. A method for producing a polished titanium alloy material, the method comprising:
supplying the composition for polishing a titanium alloy material obtained by the production method according to claim 15 in between a polishing pad and a titanium alloy material;
pressing the polishing pad against the titanium alloy material; and
polishing the titanium alloy material by rotating or moving the polishing pad and/or the titanium alloy material.
